(19) United States
(12) Patent Application Publication
(10) Pub. No.: US 2013/0342967 A1
(43) Pub. Date: Dec. 26, 2013

(54) METHOD FOR PREPARING CONDUCTIVE POLYMER DISPERSION, CONDUCTIVE POLYMER MATERIAL MADE THEREFROM AND SOLID ELECTROLYTIC CAPACITOR USING THE MATERIAL

(71) Applicant: FAR EASTERN NEW CENTURY CORPORATION, Taipei (TW)

(72) Inventors: Hsin-Kai Lai, Taipei (TW); Chih-Yuan Tseng, Taipei (TW)

(73) Assignee: FAR EASTERN NEW CENTUTY CORPORATION, Taipei (TW)

(21) Appl. No.: 13/718,410

(22) Filed: Dec. 18, 2012

(30) Foreign Application Priority Data
Jun. 26, 2012 (TW) 101122871

(51) Int. Cl. B01J 19/12; H01G 9/15; H01G 9/032; H01G 9/025

(52) U.S. Cl. CPC B01J 19/126; H01G 9/025; H01G 9/15; H01G 9/032
USPC 361/525; 204/157.6; 252/62.2

(57) ABSTRACT

The present invention provides a method for preparing a conductive polymer dispersion, including: adding a conductive compound, a polyanion, and an oxidant to a solvent; and polymerizing the conductive compound with microwaves. The present invention further provides a conductive polymer material made from the conductive polymer dispersion and a solid electrolyte capacitor using the conductive polymer material. Compared to a conventional method, the conductive polymer is prepared by the method of the present invention in a shorter time and environmental friendly. Moreover, the conductive polymer material made from the dispersion exhibits a high conductivity.

### BACKGROUND OF THE INVENTION

1. Field of the Invention

The present invention relates to a method for preparing a conductive polymer dispersion, a conductive polymer material made therefrom, and a solid electrolyte capacitor using the material.

2. Description of the Related Art

In recent years, due to the improvement in electrical properties and processability of conductive polymers, the economic benefits brought by the conductive polymers gradually draw more and more attention. Known π-conjugated conductive polymers include polypyrroles, polythiophenes, polyanilines, polyphenylenes, polyacetylenes, and poly(p-phenylene-vinylenes), or derivatives thereof. The conductive polymer layer has numerous uses in the industry, for example, as a counter electrode in a capacitor, a solid electrolyte, and an antistatic/static dissipative coating.

The conductive polymer is prepared by chemically oxidizing or electrochemically oxidizing a monomer (for example, optionally substituted thiophenes, anilines, pyrroles, and oligomers and derivatives thereof), in which due to the simple and inexpensive process, chemical oxidative polymerization is more popular. For example, U.S. Pat. No. 5,035,926 discloses a method for preparing poly(3,4-ethylenedioxythiophene) through oxidative polymerization of 3,4-ethylenedioxythiophene (EDOT or EDT), and the resulting polythiophene has a high electrical conductivity.

However, the processablity of poly(3,4-ethylenedioxythiophene) is poor. In order to improve the processablity, U.S. Pat. No. 5,300,575 discloses that a polyanion derived from poly(p-styrene sulfonic acid) is used, so that the conductive polymer has a high polymerization rate, can be stably formed in a liquid state, and still has an antistatic property in a normal atmospheric humidity (see U.S. Pat. No. 5,300,575, column 1, lines 60 to 68). However, the method suffers from a polymerization time of up to 24 hrs.

US 2011/0049433 discloses an improved method for preparing an aqueous or non-aqueous conductive polymer dispersion, in which ultrasonic waves are used to shorten the reaction time and decrease the viscosity of the dispersion. Although the reaction time can be shortened by ultrasonic waves in the method, ferric sulfate is still required to be added in the reaction as a catalyst for the reaction of the oxidant. However, an ion exchange resin waste resulting from the additionally added catalyst in a subsequent deionization process causes adverse impacts on the environment.

US 2011/0122546 and US 2011/0233450 disclose an improved method for preparing a conductive polymer, through which a conductive polymer having a high conductivity and a solid electrolyte capacitor having a low equivalent series resistance (ESR) can be produced. Although in the methods, the use of ferric sulfate as a catalyst for the reaction of the oxidant is not mentioned, a reaction time of at least 50 hrs is still required.

In view of the foregoing, there is still a need in the industry for an economical and environmentally friendly method for preparing a conductive polymer, through which the resulting conductive polymer material has a high conductivity.

### SUMMARY OF THE INVENTION

To solve one of the above problems, the present invention is directed to a method for preparing a conductive polymer dispersion. Specifically, the present invention is directed to a method for preparing a conductive polymer dispersion, which has a short reaction time and is friendly to the environment, and a conductive polymer material made therefrom and having a low surface resistance (that is, a high conductivity). According to the present invention, the method for preparing the conductive polymer dispersion includes: adding a conductive compound, a polyanion, and an oxidant to a solvent; and polymerizing the conductive compound with microwaves.

The present invention is further directed to a conductive polymer material, which is formed by removing the solvent from the conductive polymer dispersion prepared above.

The present invention is further directed to a solid electrolyte capacitor including a solid electrolyte layer, in which the solid electrolyte layer includes the conductive polymer material.

The present invention is further directed to a method for preparing a solid electrolyte capacitor, which includes: forming a dielectric layer on an anode; and applying the conductive polymer dispersion on the dielectric layer or immersing the dielectric layer in the conductive polymer dispersion, to form a solid electrolyte layer including the conductive polymer material on the dielectric layer.

Compared with currently used methods, the method for preparing a conductive polymer dispersion according to the present invention has a shorter reaction time. In addition, because no catalyst is used in the method of the present invention, the subsequent recovery of catalyst by using, for example, an ion exchange resin, is not required, so the method is friendly to the environment. Moreover, through the method of the present invention, a conductive polymer material having a reduced surface resistance can be obtained.

### BRIEF DESCRIPTION OF THE DRAWINGS

FIG. 1 shows a solid electrolyte capacitor according to an embodiment of the present invention.

### DETAILED DESCRIPTION OF THE INVENTION

The method for preparing a conductive polymer dispersion according to the present invention includes: adding a conductive compound, a polyanion, and an oxidant to a solvent; and polymerizing the conductive compound with microwaves.

The conductive compound used in the present invention is generally a monomer capable of generating a conductive polymer and a derivative thereof, an oligomer and a derivative thereof, and any combination thereof.

The monomer useful in the present invention is known in the art, and for example, may be selected from the group consisting of pyrrole, thiophene, aniline, and a mixture thereof.

The term “oligomer” used herein has a general meaning known in the art, and refers to, for example, a compound formed by a finite number of the monomer, such as a dimer, a trimer, a tetramer or a pentamer of the monomer capable of producing the conductive polymer.

The term “derivative of the monomer” used herein has a general meaning known in the art, and refers to, for example, an above-mentioned but substituted monomer.

The term “derivative of the oligomer” used herein has a general meaning known in the art, and refers to, for example, an above-mentioned but substituted oligomer.

For example, “pyrrole” and “a pyrrole derivative” refer to monomers capable of producing a conductive polymer having a similar structure to that of pyrrole after polymerization.

The pyrrole derivative useful in the present invention includes, but is not limited to, a 3-alkylpyrrole, such as 3-hexylpyrrole; a 3,4-dialkylpyrrole, such as 3,4-dihexylpyrrole; a 3-alkoxypyrrole, such as 3-methoxypyrrole; and a 3,4-dialkoxypyrrole, such as 3,4-dimethoxypyrrole.

A thiophene derivative useful in the present invention includes, for example, but is not limited to, 3,4-ethylenedioxythiophene and a derivative thereof; a 3-alkylthiophene, such as 3-hexylthiophene; and a 3-alkoxythiophene, such as 3-methoxythiophene.

An aniline derivative useful in the present invention, includes, for example, but is not limited to, a 2-alkylaniline, such as 2-methylaniline; and a 2-alkoxyaniline, such as 2-methoxyaniline.

According to a specific embodiment of the present invention, the conductive compound used is 3,4-ethylenedioxythiophene or a derivative thereof, including, for example, but not limited to, a 3,4-(1-alkyl)ethylenedioxythiophene, such as 3,4-(1-hexyl)ethylenedioxythiophene.

The amount of the conductive compound used in the present invention is not particularly limited. However, in order to obtain a conductive polymer having an acceptable conductivity, the content of the conductive compound in the solvent is about 0.1 wt % to about 20 wt %, and preferably about 0.1 wt % to about 5 wt %.

The polyanion useful in the present invention is known in the art, and may be, for example, polycarboxylic acid (such as polyacrylic acid, polymethacrylic acid, or polymaleic acid), polysulfonic acid (such as poly(p-styrenesulfonic acid), polyestersulfonic acid and poly(2-acrylamide-2-methylproplysulfonic acid)), or a salt thereof. The salt of polysulfonic acid includes, for example, but is not limited to, a lithium salt, a sodium salt, a potassium salt and an ammonium salt of polysulfonic acid. Preferred polyanion is poly(p-styrenesulfonic acid).

The polycarboxylic acid or polysulfonic acid capable of providing the polyanion preferably has a molecular weight of 1,000 to 2,000,000, and more preferably 2,000 to 500,000. For example, a method for preparing poly(p-styrenesulfonic acid) and polyacrylic acid is disclosed in, for example, Houben Weyl, Methoden der organischen Chemie [Methods of Organic Chemistry], vol. E 20 Makromolekulare Stoffe (Macromolecular Substances), part 2, (1987), p. 1141 ff.).

The amount of the polyanion used in the present invention is not particularly limited. However, in order to obtain a conductive polymer having an acceptable conductivity, the content of the polyanion in the solvent is about 1 wt % to about 20 wt %, and preferably about 1 wt % to about 5 wt %.

The oxidant useful in the present invention is known in the art, and includes, but is not limited to, an iron (III) salt, such as FeCl₃ and Fe(ClO₄)₃; an iron (III) salt of an organic acid; hydrogen peroxide; a peroxosulfate; a persulfate; a perborate salt; and a copper salt, such as copper tetrafluoroborate. Preferred is an iron salt of organic acids or a peroxosulfate, and particularly preferred is sodium peroxodisulfate. The oxidant may be used alone or in combination.

The amount of the oxidant used in the present invention is not particularly limited. However, in order to obtain a conductive polymer having a high conductivity under a mild oxidation condition, the content of the oxidant in the solvent is about 0.1 wt % to about 15 wt %, and preferably about 0.5 wt % to about 5 wt %.

The solvent useful in the present invention may be preferably selected from solvents which have a desirable compatibility effect with the conductive compound. The solvent may be water (and preferably deionized water), an organic solvent, or an organic solvent mixed with water. The organic solvent includes an alcohol, such as methanol, ethanol, and propanol; an aromatic hydrocarbon, such as benzene, toluene and xylene; an aliphatic hydrocarbon, such as hexane; and an aprotic polar solvent, such as N,N-dimethylformamide, dimethyl sulfoxide, acetonitrile and acetone. The organic solvent may be used alone or in combination. The solvent preferably includes at least one of water, an alcohol organic solvent, and an aprotic polar solvent, and preferably includes water, ethanol, dimethyl sulfoxide, a mixture of ethanol and water, and a mixture of dimethyl sulfoxide and water.

As described above, in the method of the present invention, the conductive compound is polymerized with microwaves. For example, a solution containing a conductive compound, a polyanion, and an oxidant may be placed in a microwave reactor, and energy at a power of 150 W to 1000 W, preferably 200 W to 950 W, and more preferably 300 W to 900 W is applied.

According to a specific embodiment of the present invention, the frequency of the microwaves is in the range of 2.0 MHZ to 3.0 MHZ.

The method of the present invention is carried out in an inert environment. For example, before the oxidant is added to the solution, an inert gas is bubbled through the solution for at least 5 min, and preferably 20 min, to remove oxygen and/or moisture, thereby generating an inert environment. The inert environment mentioned herein means that the oxygen content in the solution is lower than 3 ppm. A suitable inert gas is known in the art, for example, argon, helium, or nitrogen.

The polymerization reaction of the present invention is carried out at a temperature of about 0° C. to about 35° C.; preferably at a temperature of about 6° C. to about 29° C., and more preferably at a temperature of about 9° C. to about 26° C.

In the method of the present invention, the polymerization time is in the range of about 6 to about 23 hrs, preferably in the range of about 5 to about 21 hrs, and more preferably in the range of about 3 to 6 hrs.

In the present invention, a conductivity enhancer may be further used, to enhance the conductivity of the conductive polymer dispersion of the present invention. A suitable conductivity enhancer may be one known in the art, for example, dimethyl sulfoxide.

After the dispersion of the present invention is prepared, the dispersion may be further treated with a basic and acidic ion exchange resin (for example, a basic and an acidic ion exchange resin), to remove the salts.

The present invention further provides a conductive polymer material formed by removing the solvent from the above conductive polymer dispersion. The solvent may be removed from the conductive polymer dispersion by drying. The temperature for drying is not particularly limited, provided that the solvent can be removed at the temperature. However, an upper limit of the temperature is preferably lower than 300° C., so as to avoid the deterioration of the material due to heat. The drying time can be adjusted according to the drying temperature, and is not particularly limited, provided that the conductivity of the conductive polymer is not compromised.

The conductive polymer material of the present invention may be used as a solid electrolyte layer in a solid electrolyte capacitor. The conductive polymer material has a high conductivity, from which a solid electrolyte capacitor having a low equivalent series resistance (ESR) can be made.

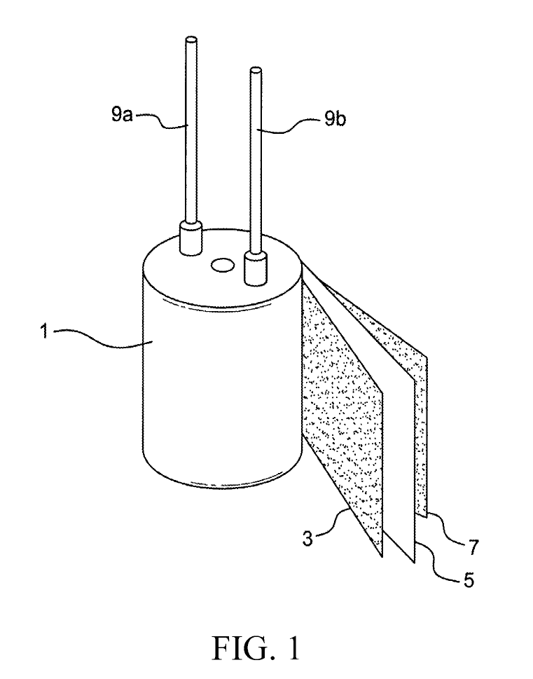

A method for fabricating a solid electrolyte layer and a solid electrolyte capacitor according to an embodiment of the present invention is described with reference to FIG. 1.

As shown in FIG. 1, a solid electrolyte capacitor 1 of the present invention includes an anode 3; a dielectric layer 5, formed on the anode 3; a cathode 7; and a solid electrolyte layer (not shown), located between the dielectric layer 5 and the cathode 7. The solid electrolyte layer includes the above-mentioned conductive polymer material. Wires 9a and 9b are terminals for connecting the cathode 7 and the anode 3 with an external circuit.

The solid electrolyte capacitor may be an aluminum solid electrolyte capacitor, a tantalum solid electrolyte capacitor, or a niobium solid electrolyte capacitor, and is prepared with known materials by a known technology. For example, the main part of the solid electrolyte capacitor is formed by an etched conductive metal foil as an anode foil and a metal foil as a cathode foil, in which the surface of the anode foil is subjected to anode oxidation treatment, and a wire is extended from the anode foil to form an anode; and a wire is extended from the cathode foil to form a cathode. A dielectric layer formed by an oxide or an analog thereof is formed on the surface of the anode foil, and is located between the anode foil and the cathode foil. The anode foil and the cathode foil may be formed with aluminum, tantalum, niobium, aluminum oxide, tantalum oxide, or niobium oxide, aluminum coated with titanium or aluminum coated with carbon.

The polymerization reaction for forming the conductive polymer dispersion of the present invention may be carried out in the capacitor or outside of the capacitor, to form a conductive polymer of the solid electrolyte layer. If the polymerization reaction is carried out outside of the capacitor, the anode foil and the cathode foil may be coated with or immersed in the conductive polymer dispersion of the present invention after the polymerization reaction, and a solid electrolyte layer is formed between the dielectric layer and the cathode foil after the solvent is removed (for example, by drying). The method for removing the solvent is as described above.

If the polymerization reaction is carried out in the capacitor, the anode foil and the cathode foil may be immersed in a solution containing a conductive compound, a polyanion, and an oxidant, then the conductive compound is polymerized with microwaves, and the solvent is removed (for example, by drying), to form a solid electrolyte layer between the dielectric layer and the cathode foil.

Alternatively, the anode foil and the cathode foil may be immersed in a first solution containing the conductive compound and then immersed in a second solution containing the polyanion and the oxidant, then the conductive compound is polymerized with microwaves, and the solvent is removed (for example, by drying), to form a solid electrolyte layer between the dielectric layer and the cathode foil.

After the solid electrolyte layer is formed in the capacitor device, the solid electrolyte capacitor is formed by using a known technology and materials. For example, the capacitor device may be encapsulated in a casing having a bottom, and a seal element having openings to expose the wires 9a and 9b may be disposed at the top of the casing, to form the solid electrolyte capacitor after sealing.

The number of the wires connected between the cathode foil and the anode foil is not particularly limited, provided that the cathode foil and the anode foil are both connected by a wire. The number of the cathode foil and the number of the anode foil are not particularly limited, for example, the number of the cathode foil may be the same as, or greater than that of the anode foil.

The present invention is further exemplarily described with reference to the following specific implementation aspects.

### EXAMPLES

### Example 1

221.45 g of deionized water was added to a 500-ml jacketed glass container, and then 8.75 g of an aqueous poly(p-styrenesulfonic acid) solution (30 wt %, average molecular weight Mw=75,000 g/mole) was added. Nitrogen was introduced while the solution was stirred to remove oxygen, and 1.065 g of 3,4-ethylenedioxythiophene (EDOT) was added in an nitrogen atmosphere. 22.475 g of sodium peroxodisulfate (11 wt %) was added, the container was placed in a microwave reactor, and the reaction was carried out with microwaves at a power of 500 W and 2.45 MHZ, with continuous stirring, until the reaction was completed (as confirmed by thin layer chromatography plate). The reaction time was 5 hrs in total. During the reaction, circulating water was injected via a thermostatic controller into the jacket of the glass container, to maintain the reaction temperature at 25° C. As a result, a dispersion was obtained.

The dispersion obtained after reaction was desalted by adding 25 g of Lewatit MP 62 (a basic ion exchange substance, Lanxess AG) and 25 g of Lewatit S 100 (an acidic ion exchange substance, Lanxess AG) and stirring for 2 hrs by a magnetic stirrer, and then the ion exchange substance was filtered off by filter cloth. 9.5 g of the desalted solution, 9.5 g of isopropanol (IPA), and 1 g of dimethyl sulfoxide (to adjust the leveling property and enhance the conductivity) were fully mixed. A clean PET film was positioned on a wire-bar coating machine, and 2 ml of the mixture was uniformly coated on the PET film by using a gauge 5 bar. Then, the film was dried for 3 min in a hot air oven at 130° C. The surface resistance was measured by a surface resistance tester (Mitsubishi MCP-T610) at a voltage of 10 V.

### Example 2

The reaction scheme and conditions were the same as those in Example 1, except that the parameters of the microwave reactor were changed to 800 W, and 2.45 MHZ. 4 hrs were required to complete the reaction.

### Example 3

The reaction scheme and conditions were the same as those in Example 1, except that the parameters of the microwave reactor were changed to 200 W, and 2.45 MHZ. 21 hrs were required to complete the reaction.

### Comparative Example 1

The reaction scheme and conditions were the same as those in Example 1, except that the microwave reactor was not used, and stirring was continued until the reaction was completed. 24 hrs were required to complete the reaction.

### Comparative Example 2

The reaction scheme and conditions were the same as those in Example 1, except that instead of the microwave reactor, ultrasonic waves at a power of 150 W and 43 KHZ was used, and the reaction temperature was maintained at 24° C. 13 hrs were required to complete the reaction.

### Comparative Example 3

The reaction scheme and conditions were the same as those in Comparative Example 2, except that before the reaction was accelerated by ultrasonic waves, 0.054 g of ferric sulfate was added for use as a catalyst to shorten the reaction time. 6 hrs were required to complete the reaction.

### Comparative Example 4

The reaction scheme and conditions were the same as those in Comparative Example 1, except that when the aqueous sodium peroxodisulfate solution was added, 0.054 g of ferric sulfate was also added for use as a catalyst to shorten the reaction time. 22 hrs were required to complete the reaction.

Examples and Comparative Examples prepared through the above processes are compared as shown in Tables below.

TABLE 1

| | Comparative | Comparative | | |
|---|---|---|---|---|
| | Example 1 | Example 2 | Example 1 | Example 2 |
| Reaction | — | Ultrasonic | 500 W | 800 W |
| environment | | waves | Microwaves | Microwaves |
| Reaction | EDOT | EDOT | EDOT | EDOT |
| monomer | | | | |
| Dispersing | PSS | PSS | PSS | PSS |
| agent | | | | |
| Oxidant | Na₂S₂O₈ | Na₂S₂O₈ | Na₂S₂O₈ | Na₂S₂O₈ |
| Catalyst | — | — | — | — |
| Reaction | 25 | 24 | 25 | 24 |
| temperature | | | | |
| (° C.) | | | | |
| Reaction | 24 | 13 | 5 | 4 |
| time (hr) | | | | |
| Surface | 9200 | 8150 | 1250 | 1420 |
| resistance | | | | |
| (Ω/sq) | | | | |

It can be known from Table 1 that in the case that no catalyst is added, use of the microwaves can not only shorten the reaction time greatly, but also lower the surface resistance significantly (that is, the surface conductivity is improved).

TABLE 2

| | Compar- | Compar- | Compar- | | |
|---|---|---|---|---|---|
| | ative | ative | ative | | |
| | Example 1 | Example 3 | Example 4 | Example 1 | Example 2 |
| Reaction | — | Ultra- | — | 500 W | 800 W |
| environment | | sonic | | Micro- | Micro- |
| | | waves | | waves | waves |
| Reaction | EDOT | EDOT | EDOT | EDOT | EDOT |
| monomer | | | | | |
| Dispersing | PSS | PSS | PSS | PSS | PSS |
| agent | | | | | |
| Oxidant | Na₂S₂O₈ | Na₂S₂O₈ | Na₂S₂O₈ | Na₂S₂O₈ | Na₂S₂O₈ |
| Catalyst | — | Fe₂SO₄ | Fe₂SO₄ | — | — |
| Reaction | 25 | 24 | 25 | 25 | 24 |
| temperature | | | | | |
| (° C.) | | | | | |
| Reaction | 24 | 6 | 22 | 5 | 4 |
| time (hr) | | | | | |
| Surface | 9200 | 9100 | 7200 | 1250 | 1420 |
| resistance | | | | | |
| (Ω/sq) | | | | | |

It can be known from Table 2 that addition of the catalyst with stirring or in an ultrasonic wave reaction environment can accelerate the reaction, but the efficacy is not high enough compared with that of the microwave reactor (in which no catalyst is added), and the surface resistance is still high.

TABLE 3

| | Comparative | | | |
|---|---|---|---|---|
| | Example 1 | Example 1 | Example 2 | Example 3 |
| Reaction | — | 500 W | 800 W | 200 W |
| environment | | Microwaves | Microwaves | Microwaves |
| Reaction | EDOT | EDOT | EDOT | EDOT |
| monomer | | | | |
| Dispersing | PSS | PSS | PSS | PSS |
| agent | | | | |
| Oxidant | Na₂S₂O₈ | Na₂S₂O₈ | Na₂S₂O₈ | Na₂S₂O₈ |
| Catalyst | — | — | — | — |
| Reaction | 25 | 25 | 24 | 24 |
| temperature | | | | |
| (° C.) | | | | |
| Reaction | 24 | 5 | 4 | 21 |
| time (hr) | | | | |
| Surface | 9200 | 1250 | 1420 | 1200 |
| resistance | | | | |
| (Ω/sq) | | | | |

It can be known from Table 3 that a reaction environment of low-power microwaves at a power of 200 W can facilitate the decrease of the surface resistance, but the effect for shortening the reaction time is not as obvious as that of microwaves at a power of 500 W or 800 W.

It can be known from above results that use of microwaves can shorten the polymerization time of the conductive compound, and decrease the surface resistance of the resulting conductive polymer. In addition, in the method of the present invention, a catalyst is not required to facilitate the polymerization, and a subsequent recovery means for the catalyst is not required, so the method is friendly to the environment. The present invention can be widely used in the industries using the capacitor, for example, an LED driving power supply, an electronic energy saving lamp and a rectifier, a vehicle electronic device, a computer mainboard, an inverter, network communications, power supply for medical equipment, UPS, and other advanced fields.

What is claimed is:

1. A method for preparing a conductive polymer dispersion, comprising:
adding a conductive compound, a polyanion, and an oxidant to a solvent; and
polymerizing the conductive compound with microwaves.

2. The method according to claim 1, wherein the polymerization reaction is carried out with microwave energy at a power of 150 W to 1000 W.

3. The method according to claim 2, wherein the polymerization reaction is carried out with microwave energy at a power of 200 W to 950 W.

4. The method according to claim 3, wherein the polymerization reaction is carried out with microwave energy at a power of 300 W to 900 W.

5. The method according to claim 1, wherein the frequency of the microwaves is in the range of 2.0 MHZ to 3.0 MHZ.

6. The method according to claim 1, wherein the polymerization reaction is carried out in an inert environment.

7. The method according to claim 1, wherein the conductive compound is selected from the group consisting of pyrrole, thiophene, and aniline and a derivative and oligomer thereof.

8. The method according to claim 1, wherein the oxidant is selected from the group consisting of an iron (III) salt, an iron (III) salt of an organic acid, a peroxosulfate, a persulfate, a perborate salt, a copper salt, and an inorganic acid containing an organic group.

9. A conductive polymer material, formed by removing the solvent from the conductive polymer dispersion prepared by the method according to claim 1.

10. A solid electrolyte capacitor, comprising:
an anode;
a dielectric layer, formed on the anode;
a cathode; and
a solid electrolyte layer, located between the dielectric layer and the cathode,
wherein the solid electrolyte layer comprises the conductive polymer material according to claim 9.
